(19) United States
(12) Patent Application Publication
(10) Pub. No.: US 2021/0122364 A1
(43) Pub. Date: Apr. 29, 2021

(54) VEHICLE COLLISION AVOIDANCE APPARATUS AND METHOD

(71) Applicant: LG ELECTRONICS INC., Seoul (KR)

(72) Inventors: Dong Ha LEE, Seoul (KR); Chong Ook YOON, Seoul (KR)

(21) Appl. No.: 16/782,323

(22) Filed: Feb. 5, 2020

(30) Foreign Application Priority Data
Oct. 29, 2019 (KR) 10-2019-0135520

(51) Int. Cl. B60W 30/09; B60W 30/095; B60W 10/04; B60W 10/20; G01S 17/931; G01S 17/86; G06K 9/00; G06K 9/62; G08G 1/16; G06N 3/04; G06N 3/08

(52) U.S. Cl. CPC B60W 30/09; G06K 9/6288; B60W 10/04; B60W 10/20; G01S 17/931; G01S 17/86; G06K 9/00805; G06K 9/6232; G06K 9/6256; G08G 1/166; G06N 3/04; G06N 3/08; B60W 2420/42; B60W 2420/52; B60W 2554/4042; B60W 2554/4043; B60W 2554/4044; B60W 2556/45; B60W 2554/801; B60W 2554/802; B60W 2554/402; B60W 30/0956

(57) ABSTRACT

A vehicle collision avoidance apparatus includes an interface and a processor. The interface receives a point cloud map representing a surrounding environment and an image of the surrounding environment. The processor is configured to: determine whether an object that is expected to collide with the vehicle is present in the point cloud map; activate an avoidance traveling process; set a collision avoidance space defined to avoid the object according to the avoidance traveling process; identify a type of the object based on a region of interest that is set according to a location of the object in the image; based on identifying the type of the object, determine whether the type of the object corresponds to a set avoidance target; and drive the vehicle to the collision avoidance space in response to a determination that the type of the object corresponds to the set avoidance target.

### CROSS-REFERENCE TO RELATED APPLICATION

This present application claims the benefit of priority to Korean Patent Application No. 10-2019-0135520, filed on Oct. 29, 2019, in the Korean Intellectual Property Office, the entire disclosure of which is incorporated herein by reference.

### TECHNICAL FIELD

The present disclosure relates to a vehicle collision avoidance apparatus and method for controlling a vehicle such that the vehicle may not collide with objects around the vehicle.

### BACKGROUND

When a vehicle is traveling, a driver's field of view may be limited. In some cases, even when a camera is installed outside the vehicle, it may be difficult for the driver to recognize the surrounding environment quickly and accurately using the camera, which may lead to an accident.

In some examples, as a measure for reducing traffic accidents, cameras may be installed on the front, rear, left, and right of the outside of a vehicle and each camera may be connected to a navigation. Each camera may photograph a blind spot that the driver cannot see, and provide the photographed blind spot to the navigation. In some examples, it is determined whether a side vehicle is present in an image acquired from a camera of a vehicle, and a steering angle may be controlled to avoid a collision with the side vehicle. In some cases, the driver may be alerted of the presence of the side vehicle so as to prevent a collision between the vehicles from occurring.

In some cases, collision avoidance using cameras may be limited in quickly detecting movement of other vehicles.

### SUMMARY

The present disclosure describes a vehicle collision avoidance apparatus that may quickly and accurately recognize information on an object (for example, information on at least one of a speed of the object, a traveling direction of the object, a size of the object, or a distance between the object and a vehicle) in the surrounding environment using a light detection and ranging device (LIDAR) installed in the vehicle along with a camera installed in the vehicle.

The present disclosure also describes a vehicle collision avoidance apparatus that may prevent a collision in advance or minimize damage caused by a collision by causing the vehicle to perform a collision prevention operation (for example, deceleration, acceleration, or steering) in preparation for the possibility of collision between a vehicle and a potentially threatening object which can threaten the vehicle, in response to a determination that an object in the surrounding environment is a potentially threatening object, based on a point cloud map generated through a LIDAR installed in the vehicle.

The present disclosure may enable a vehicle to avoid a collision with a potentially threatening object by setting a region of interest in an image generated by a camera installed in the vehicle corresponding to a position of the potentially threatening object present in a point cloud map generated through a LIDAR installed in the vehicle, determining a type of the potentially threatening object in the region of interest as a set avoidance target, and moving the vehicle to a collision avoidance space in response to a determination that the vehicle will collide with the potentially threatening object.

The present disclosure describes a vehicle collision avoidance apparatus that may prevent a collision between a vehicle and a potentially threatening object as effectively as possible by determining a case where a collision between the vehicle and the potentially threatening object is predicted as an emergency situation, and in the emergency situation temporarily setting as a collision avoidance space not only a travelable area but also an area that in a non-emergency situation is a non-travelable area.

According to one aspect of the subject matter described in this application, a vehicle collision avoidance apparatus includes an interface and a processor. The interface is configured to: receive, from a light detection and ranging device (LIDAR) installed at a vehicle, a point cloud map representing a surrounding environment within a set range from the LIDAR; and receive, from a camera installed at the vehicle, an image of the surrounding environment. The processor is configured to: determine whether an object that is expected to collide with the vehicle is present in the point cloud map; in response to a determination that the object is present in the point cloud map, activate an avoidance traveling process; set a collision avoidance space defined to avoid the object according to the avoidance traveling process; identify a type of the object based on a region of interest that is set according to a location of the object in the image; based on identifying the type of the object, determine whether the type of the object corresponds to a set avoidance target; and drive the vehicle to the collision avoidance space in response to a determination that the type of the object corresponds to the set avoidance target.

Implementations according to this aspect may include one or more of the following features. For example, the point cloud map may include a plurality of point could maps that are received from the LIDAR based on set intervals, and the processor may be configured to: transform each point cloud map from a three-dimensional point cloud map to a two-dimensional occupancy grid map (OGM); compare OGMs of the plurality of point could maps, each OGM including an occupied area in which one or more objects are expected to be present; based on comparing the OGMs, determine movement of the one or more objects in the occupied area; based on determining the movement of the one or more objects in the occupied area, determine object information corresponding to the one or more objects in the occupied area, the object information including at least one of a speed of the one or more objects, a traveling direction of the one or more objects, a size of the one or more objects, or a distance between the one or more objects and the vehicle; and based on the object information, determine whether the one or more objects correspond to the object that is expected to collide with the vehicle.

In some implementations, the processor may be configured to determine that the one or more objects correspond to the object that is expected to collide with the vehicle based on (i) the size of the one or more objects being greater than a set size, (ii) the speed of the one or more objects toward the vehicle being greater than a set speed, and (iii) the distance between the one or more objects and the vehicle being less than a set separation distance.

In some implementations, the interface may be configured to receive a high definition (HD) map from a server, the HD map including lane information, and the processor may be configured to: estimate movement of the one or more objects based on the object information; determine whether the estimated movement of the one or more objects is normal according to the lane information in the HD map; and based on a determination that the estimated movement of the one or more objects is abnormal, determine that the one or more objects correspond to the object that is expected to collide with the vehicle.

In some implementations, the interface may be configured to receive a plurality of images from the camera at the set intervals, and each OGM may further include a non-occupied area in which no object is expected to be present. The processor may be configured to: estimate movement of the one or more objects based on the object information; based on the estimated movement of the one or more objects, determine a travelable area of the vehicle in the non-occupied area; adjust the travelable area of the vehicle based on travelable areas determined from the plurality of images; and control traveling of the vehicle based on the adjusted travelable area.

In some implementations, the processor may be configured to, before setting the collision avoidance space, cause the vehicle to perform a collision prevention operation by decelerating, accelerating, or steering the vehicle based on a distance between the object and the vehicle being greater than a set braking distance of the vehicle.

In some implementations, the processor may be configured to: determine that the vehicle is expected to collide with the object based on a distance between the object and the vehicle being less than a set braking distance of the vehicle; and in response to a determination that the vehicle is expected to collide with the object, drive the vehicle to the collision avoidance space.

In some implementations, the processor may be configured to: set an avoidance area including non-travelable areas that the vehicle is not allowed to enter; set the avoidance area and a travelable area of the vehicle as the collision avoidance space; and drive the vehicle to the collision avoidance space to avoid a collision between the vehicle and the object. In some examples, the processor may be configured to, before driving the vehicle to the collision avoidance space, transmit a message about movement of the vehicle to the collision avoidance space to another vehicle located within a set range from the vehicle.

In some implementations, the processor may be configured to: in response to a determination that the object is present in the point cloud map, set an area corresponding to spatial coordinates of the object in the image as the region of interest; increase a frame rate of the camera for capturing images of the region of interest; and identify the type of the object based on the images captured at the frame rate.

In some implementations, the processor may be configured to: perform an object identification process with the image including the region of interest; and based on performance of the object identification process, identify the type of the object and determine whether the type of the object corresponds to the set avoidance target. For instance, the object identification process may include a neural network model trained to detect a sample object in a sample image and identify a type of the sample object.

In some implementations, the processor may be configured to deactivate the avoidance traveling process in response to (i) a determination that the type of the object does not correspond to the set avoidance target or (ii) a determination that the vehicle is not expected to collide with the object.

According to another aspect, a vehicle collision avoidance method includes: receiving, from a light detection and ranging device (LIDAR) installed at a vehicle, a point cloud map representing a surrounding environment within a set range from the LIDAR; receiving, from a camera installed at the vehicle, an image of the surrounding environment; determining whether an object that is expected to collide with the vehicle is present in the point cloud map; in response to a determination that the object is present in the point cloud map, activating an avoidance traveling process; setting a collision avoidance space defined to avoid the object according to the avoidance traveling process; identifying a type of the object based on a region of interest that is set according to a location of the object in the image; based on identifying the type of the object, determining whether the type of the object corresponds to a set avoidance target; and driving the vehicle to the collision avoidance space in response to a determination that the type of the object corresponds to the set avoidance target.

Implementations according to this aspect may include one or more of the following features or features similar to those described above for the vehicle collision avoidance apparatus. For example, receiving the point cloud map may include receiving a plurality of point cloud maps from the LIDAR at set intervals. The method may further include: transforming each point cloud map from a three-dimensional point cloud map to a two-dimensional occupancy grid map (OGM); comparing OGMs corresponding to the plurality of point cloud maps, each OGM including an occupied area in which one or more objects are expected to be present; based on comparing the OGMs, determining movement of the one or more objects in the occupied area; based on determining the movement of the one or more objects in the occupied area, determining object information corresponding to the one or more objects in the occupied area, the object information including at least one of a speed of the one or more objects, a traveling direction of the one or more objects, a size of the one or more objects, or a distance between the one or more objects and the vehicle; and based on the object information, determining whether the one or more objects correspond to the object that is expected to collide with the vehicle.

In some examples, determining whether the one or more objects correspond to the object that is expected to collide with the vehicle may include: determining that the one or more objects correspond to the object that is expected to collide with the vehicle based on (i) the size of the one or more objects being greater than a set size, (ii) the speed of the one or more objects toward the vehicle being greater than a set speed, and (iii) the distance between the one or more objects and the vehicle being less than a set separation distance.

In some examples, the method may further include receiving a high definition (HD) map from a server, the HD map including lane information. In these or other examples, determining whether the one or more objects correspond to the object that is expected to collide with the vehicle may include: estimating movement of the one or more objects based on the object information; determining whether the estimated movement of the one or more objects is normal according to the lane information in the HD map; and based on a determination that the estimated movement of the one or more objects is abnormal, determining that the one or more objects correspond to the object that is expected to collide with the vehicle.

In some implementations, the method may further include, before setting the collision avoidance space, causing the vehicle to perform a collision prevention operation by decelerating, accelerating, or steering the vehicle based on a distance between the object and the vehicle being greater than a set braking distance of the vehicle. In some examples, driving the vehicle to the collision avoidance space may include: determining that the vehicle is expected to collide with the object based on a distance between the object and the vehicle being less than a set braking distance of the vehicle; and in response to a determination that the vehicle is expected to collide with the object, driving the vehicle to the collision avoidance space.

In some implementations, driving the vehicle to the collision avoidance space may include: setting an avoidance area including non-travelable areas that the vehicle is not allowed to enter; setting the avoidance area and a travelable area of the vehicle as the collision avoidance space; and driving the vehicle to the collision avoidance space to avoid a collision between the vehicle and the object.

In some examples, identifying the type of the object in the region of interest in the image may include: in response to a determination that the object is present in the point cloud map, setting an area corresponding to spatial coordinates of the object in the image as the region of interest; increasing a frame rate of the camera for capturing images of the region of interest; and identifying the type of the object based on the images captured at the frame rate.

In addition, a method and a system for implementing the present disclosure, and a computer-readable recording medium having a computer program stored therein to perform the method, may be further provided.

Other aspects and features as well as those described above will become clear from the accompanying drawings, claims, and the detailed description of the present disclosure.

In some implementations, it may be possible to quickly and accurately recognize information on an object (for example, information on at least one of a speed of the object, a traveling direction of the object, a size of the object, or a distance between the object and a vehicle) in the surrounding environment using a LIDAR installed in the vehicle along with a camera installed in the vehicle.

In some implementations, it may be possible to prevent a collision in advance or minimize damage caused by a collision that does occurs, by causing a vehicle to perform a collision prevention operation (for example, deceleration, acceleration, or steering) in preparation for the possibility of collision between a vehicle and a potentially threatening object which can threaten the vehicle, in response to a determination that an object in the surrounding environment is a potentially threatening object, based on a point cloud map generated through a LIDAR installed in the vehicle.

In some implementations, it may be possible to enable a vehicle to avoid a collision with a potentially threatening object by setting a region of interest in an image generated by a camera installed in the vehicle corresponding to a position of the potentially threatening object present in a point cloud map generated through a LIDAR installed in the vehicle, determining a type of the potentially threatening object in the region of interest as a set avoidance target, and moving the vehicle to a collision avoidance space in response to a determination that the vehicle will collide with the potentially threatening object.

In some implementations, it may be possible to prevent a collision between a vehicle and a potentially threatening object as effectively as possible by determining a case where a collision between the vehicle and the potentially threatening object is predicted as an emergency situation, and in the emergency situation temporarily setting as a collision avoidance space not only a travelable area but also an area that in a non-emergency situation is a non-travelable area.

### BRIEF DESCRIPTION OF THE DRAWINGS

The above and other aspects, features, and advantages of the present disclosure will become apparent from the detailed description of the following aspects in conjunction with the accompanying drawings.

FIG. 1 is a diagram illustrating an example vehicle including an example vehicle collision avoidance apparatus.

FIG. 2 is a block diagram illustrating an example system including the vehicle collision avoidance apparatus.

FIG. 3 is a diagram showing an example of an autonomous vehicle and a fifth generation (5G) network in a 5G communication system.

FIG. 4 is a diagram illustrating an example configuration of the vehicle collision avoidance apparatus.

FIG. 5 is a diagram illustrating another example configuration of the vehicle collision avoidance apparatus.

FIG. 6 is a diagram illustrating an example configuration of determining movement and a travelable area of an object using a LIDAR in the vehicle collision avoidance apparatus.

FIG. 7 is a diagram illustrating an example process for checking a potentially threatening object in the vehicle collision avoidance apparatus.

FIG. 8 is a diagram illustrating another example process for checking the potentially threatening object in the vehicle collision avoidance apparatus.

FIGS. 9 and 10 are diagrams illustrating an example processing method for determining an example of a potentially threatening object in the vehicle collision avoidance apparatus.

FIG. 11 is a flowchart illustrating an example of a vehicle collision avoidance method.

### DETAILED DESCRIPTION

The implementations disclosed in the present specification will be described in greater detail with reference to the accompanying drawings, and throughout the accompanying drawings, the same reference numerals are used to designate the same or similar components and redundant descriptions thereof are omitted.

The vehicle described in the present disclosure may include, but is not limited to, a vehicle having an internal combustion engine as a power source, a hybrid vehicle having an engine and an electric motor as a power source, and an electric vehicle having an electric motor as a power source.

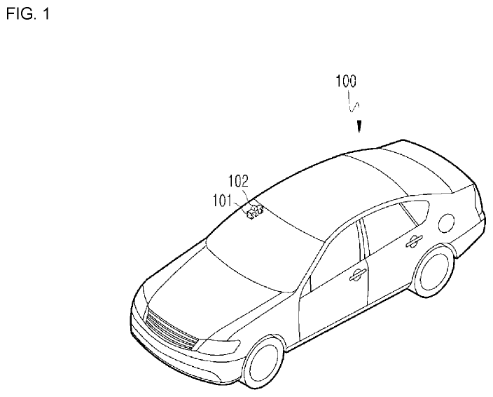

FIG. 1 is a diagram illustrating an example vehicle including a vehicle collision avoidance apparatus.

Referring to FIG. 1, in a vehicle 100 to which a vehicle collision avoidance apparatus is applied, for example, a LIDAR 101 and a camera 102 may be installed at the same position. Here, the LIDAR 101 and the camera 102 may be installed outside the vehicle 100, and may be installed at one or more positions (for example, a front surface, a side surface, and a rear surface of the vehicle).

The LIDAR 101 may irradiate, for example, vertical and horizontal light to the surrounding environment in a set range, and generate a point cloud map of the surrounding environment based on the reflected and received light.

In addition, the camera 102 may generate an image of the surrounding environment using at least one of a red, green, and blue (RGB) sensor, an infrared radiation (IR) sensor, or a time of flight (TOF) sensor.

The vehicle collision avoidance apparatus is mounted inside the vehicle 100, and is able to receive a point cloud map and an image, respectively, from the LIDAR 101 and the camera 102 that photograph the outside of the vehicle 100, and recognize an object present in the surrounding environment of the vehicle based on the point cloud map and the image.

The vehicle collision avoidance apparatus may first activate an avoidance traveling algorithm when an object recognized by the point cloud map is a potentially threatening object that is likely to threaten the vehicle 100, perform collision prevention operations (for example, deceleration, acceleration, steering) according to the avoidance traveling algorithm, and set a collision avoidance space in advance. In addition, based on the image received from the camera, the vehicle collision avoidance apparatus may determine that the type of the potentially threatening object is a set avoidance target (for example, a vehicle or a person), and move the vehicle 100 to the collision avoidance space set in advance in response to a determination that the vehicle 100 will collide with the potentially threatening object. Accordingly, a collision avoidance response speed of the vehicle 100 can be increased, and the collision with the potentially threatening object can be quickly avoided.

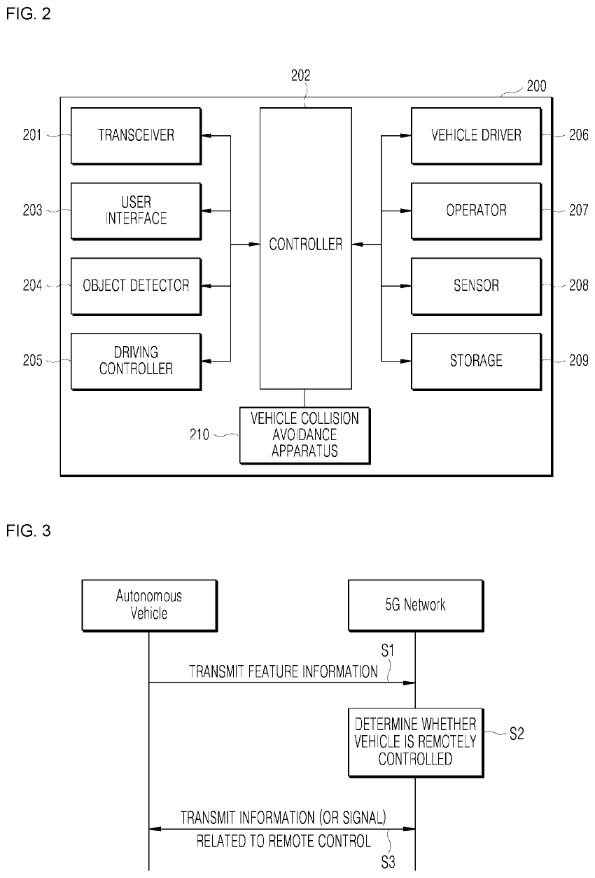

FIG. 2 is a block diagram illustrating an example system including the vehicle collision avoidance apparatus.

Referring to FIG. 2, a system 200 to which the vehicle collision avoidance apparatus is applied may be included in the vehicle 100, and may include a transceiver 201, a controller 202, a user interface 203, an object detector 204, a driving controller 205, a vehicle driver 206, an operator 207, a sensor 208, a storage 209, and a vehicle collision avoidance apparatus 210.

In some implementations, a system to which a vehicle collision avoidance apparatus is applied may include constituent elements other than the constituent elements shown and described in FIG. 2, or may not include some of the constituent elements shown and described in FIG. 2. In some implementations, the controller 202 may include one or more of the transceiver 201, the user interface 203, the object detector 204, the driving controller 205, the storage 209, and the vehicle collision avoidance apparatus 210.

The vehicle 100 may be switched from an autonomous mode to a manual mode, or switched from the manual mode to the autonomous mode depending on the driving situation. Here, the driving situation may be judged by at least one of the information received by the transceiver 201, the external object information detected by the object detector 204, or the navigation information acquired by the navigation module.

The vehicle 100 may be switched from the autonomous mode to the manual mode, or from the manual mode to the autonomous mode, according to a user input received through the user interface 203.

When the vehicle 100 is operated in the autonomous driving mode, the vehicle 100 may be operated under the control of the operator 207 that controls driving, parking, and unparking. When the vehicle 100 is operated in the manual mode, the vehicle 100 may be operated by an input of the driver's mechanical driving operation.

The transceiver 201 is a module for performing communication with an external device. Here, the external device may be a user terminal, another vehicle, or a server.

The transceiver 201 may include at least one of a transmission antenna, a reception antenna, a radio frequency (RF) circuit capable of implementing various communication protocols, or an RF element in order to perform communication.

The transceiver 201 may perform short range communication, GPS signal reception, V2X communication, optical communication, broadcast transmission/reception, and intelligent transport systems (ITS) communication functions.

The transceiver 201 may further support other functions than the functions described, or may not support some of the functions described, in some implementations.

The transceiver 201 may support short-range communication by using at least one of Bluetooth, Radio Frequency Identification (RFID), Infrared Data Association (IrDA), Ultra Wideband (UWB), ZigBee, Near Field Communication (NFC), Wireless Fidelity (Wi-Fi), Wi-Fi Direct, or Wireless Universal Serial Bus (Wireless USB) technologies.

The transceiver 201 may form short-range wireless communication networks so as to perform short-range communication between the vehicle 100 and at least one external device.

The transceiver 201 may include a Global Positioning System (GPS) module or a Differential Global Positioning System (DGPS) module for acquiring position information of the vehicle 100.

The transceiver 201 may include a module for supporting wireless communication between the vehicle 100 and a server (V2I: vehicle to infrastructure), between the vehicle 100 and another vehicle (V2V: vehicle to vehicle), or between the vehicle 100 and a pedestrian (V2P: vehicle to pedestrian). That is, the transceiver 201 may include a V2X communication module. The V2X communication module may include an RF circuit capable of implementing V2I, V2V, and V2P communication protocols.

The transceiver 201 may receive a danger information broadcast signal transmitted by another vehicle through the V2X communication module, and may transmit a danger information inquiry signal and receive a danger information response signal in response thereto.

The transceiver 201 may include an optical communication module for communicating with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 100.

The transceiver 201 may include a broadcast communication module for receiving a broadcast signal from an external broadcast management server through a broadcast channel, or transmitting a broadcast signal to the broadcast management server. The broadcast channel may include a satellite channel and a terrestrial channel. Examples of the broadcast signal may include a TV broadcast signal, a radio broadcast signal, and a data broadcast signal.

The transceiver 201 may include an ITS communication module for exchanging information, data, or signals with a traffic system. The ITS communication module may provide acquired information and data to the traffic system. The ITS communication module may receive information, data or signals from the traffic system. For example, the ITS communication module may receive road traffic information from the traffic system, and provide the information to the controller 202. For example, the ITS communication module may receive a control signal from the traffic system, and provide the control signal to the controller 202 or a processor provided in the vehicle 100.

In some implementations, the overall operation of each module of the transceiver 201 may be controlled by a separate processor provided in the transceiver 201. The transceiver 201 may include a plurality of processors, or may not include a processor. When the transceiver 201 does not include a processor, the transceiver 201 may be operated under the control of the processor of another device in the vehicle 100 or the controller 202.

The transceiver 201 may implement a vehicle display device together with the user interface 203. In this case, the vehicle display device may be referred to as a telematics device or an audio video navigation (AVN) device.

FIG. 3 is a diagram showing an example of operation of an autonomous vehicle and a 5G network in a 5G communication system.

The transceiver 201 may transmit specific information to the 5G network when the vehicle 100 is operated in the autonomous mode (S1).

In this case, the specific information may include autonomous driving-related information.

The autonomous driving-related information may be information directly related to driving control of the vehicle. For example, the autonomous driving-related information may include one or more of object data indicating an object around the vehicle, map data, vehicle state data, vehicle location data, and driving plan data.

The autonomous driving-related information may further include service information required for autonomous driving. For example, the specific information may include information about the destination and the stability level of the vehicle, which are inputted through the user interface 203.

In addition, the 5G network can determine whether the vehicle is remotely controlled (S2).

Here, the 5G network may include a server or a module which performs remote control related to autonomous driving.

The 5G network may transmit information (or a signal) related to the remote control to an autonomous vehicle (S3).

As described above, the information related to the remote control may be a signal applied directly to the self-driving vehicle, and may further include service information necessary for autonomous driving. In one implementation of the present disclosure, the autonomous vehicle can provide autonomous driving related services by receiving service information such as insurance and danger sector information selected on a route through a server connected to the 5G network.

The vehicle 100 is connected to an external server through a communication network, and is capable of moving along a predetermined route without driver intervention using the autonomous driving technology.

In the following implementations, the user may be interpreted as a driver, a passenger, or the owner of a user terminal.

When the vehicle 100 is traveling in the autonomous mode, the type and frequency of accidents may vary greatly depending on the ability to sense the surrounding risk factors in real time. The route to the destination may include sectors having different levels of risk due to various causes such as weather, terrain characteristics, traffic congestion, and the like.

At least one of the autonomous vehicle, the user terminal, or the server of the present disclosure may be linked to or integrated with an artificial intelligence module, a drone (an unmanned aerial vehicle, UAV), a robot, an augmented reality (AR) device, a virtual reality (VR) device, and a device related to 5G services.

For example, the vehicle 100 may operate in association with at least one AI module or robot included in the vehicle 100, during autonomous driving.

For example, the vehicle 100 may interact with at least one robot. The robot may be an autonomous mobile robot (AMR). The mobile robot is capable of moving by itself, may freely move, and may be equipped with a plurality of sensors so as to be capable of avoiding obstacles during traveling. The mobile robot may be a flying robot (for example, a drone) having a flight device. The mobile robot may be a wheeled robot having at least one wheel and moving by rotation of the wheel. The mobile robot may be a legged robot having at least one leg and being moved using the leg.

The robot may function as a device that complements the convenience of a vehicle user. For example, the robot may perform a function of moving a load placed on the vehicle 100 to the final destination of the user. For example, the robot may perform a function of guiding the user, who has alighted from the vehicle 100, to the final destination. For example, the robot may perform a function of transporting the user, who has alighted from the vehicle 100, to the final destination.

At least one electronic device included in the vehicle 100 may communicate with the robot through a communication device.

At least one electronic device included in the vehicle 100 may provide the robot with data processed by at least one electronic device included in the vehicle. For example, at least one electronic device included in the vehicle 100 may provide the robot with at least one of object data indicating an object around the vehicle, HD map data, vehicle state data, vehicle position data, or driving plan data.

At least one electronic device included in the vehicle 100 can receive data processed by the robot from the robot. At least one electronic device included in the vehicle 100 can receive at least one of sensing data, object data, robot state data, robot position data, and movement plan data of the robot, which are generated by the robot.

At least one electronic device included in the vehicle 100 may generate a control signal based on data received from the robot. For example, at least one electronic device included in the vehicle may compare the information about the object generated by the object detection device with the information about the object generated by the robot, and generate a control signal based on the comparison result. At least one electronic device included in the vehicle 100 may generate a control signal so as to prevent interference between the route of the vehicle and the route of the robot.

At least one electronic apparatus included in the vehicle 100 may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning on input data using at least one artificial neural network (ANN). The artificial intelligence module may output driving plan data through machine learning on the input data.

At least one electronic device included in the vehicle 100 can generate a control signal based on data which is output from the AI module.

At least one electronic device included in the vehicle 100 may receive data processed by artificial intelligence, from an external device, via a communication device, in some implementations. At least one electronic device included in the vehicle 1000 may generate a control signal based on data processed by artificial intelligence.

Artificial intelligence (AI) is an area of computer engineering science and information technology that studies methods to make computers mimic intelligent human behaviors such as reasoning, learning, self-improving, and the like.

In addition, artificial intelligence does not exist on its own, but is rather directly or indirectly related to a number of other fields in computer science. In recent years, there have been numerous attempts to introduce an element of the artificial intelligence into various fields of information technology to solve problems in the respective fields.

The controller 202 may be implemented by using at least one of an application specific integrated circuit (ASIC), a digital signal processor (DSP), a digital signal processing device (DSP), a programmable logic device (PLD), a field programmable gate array (FPGA), a processor, a controller, a micro-controller, a microprocessor, or other electronic units for performing other functions.

The user interface 203 is used for communication between the vehicle 100 and the vehicle user. The user interface 1300 may receive an input signal of the user, transmit the received input signal to the controller 202, and provide information held by the vehicle 100 to the user by the control of the controller 202. The user interface 203 may include, but is not limited to, an input module, an internal camera, a bio-sensing module, and an output module.

The input module is for receiving information from a user. The data collected by the input module may be identified by the controller 202 and processed by the user's control command.

The input module may receive the destination of the vehicle 100 from the user and provide the destination to the controller 202.

The input interface may input to the controller 202 a signal for designating and deactivating at least one of the plurality of sensor modules of the object detector 204 according to the user's input.

The input module may be disposed inside the vehicle. For example, the input module may be disposed in one area of a steering wheel, one area of an instrument panel, one area of a seat, one area of each pillar, one area of a door, one area of a center console, one area of a head lining, one area of a sun visor, one area of a windshield, or one area of a window.

The output module is for generating an output related to visual, auditory, or tactile information. The output module may output a sound or an image.

The output module may include at least one of a display module, an acoustic output module, or a haptic output module.

The display module may display graphic objects corresponding to various information.

The display module may include at least one of a liquid crystal display (LCD), a thin film transistor liquid crystal display (TFT LCD), an organic light emitting diode (OLED), a flexible display, a 3D display, or an e-ink display.

The display module may have a mutual layer structure with a touch input module, or may be integrally formed to implement a touch screen.

The display module may be implemented as a head up display (HUD). When the display module is implemented as an HUD, the display module may include a projection module to output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The user interface 203 may include a plurality of display modules.

The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electric signal provided from the controller 202 into an audio signal, and output the audio signal. To this end, the sound output module may include one or more speakers.

The haptic output module may generate a tactile output. For example, the haptic output module may operate to allow the user to perceive the output by vibrating a steering wheel, a seat belt, and a seat.

The object detector 204 is for detecting an object located outside the vehicle 100. The object detector 2400 may generate object information based on the sensing data, and transmit the generated object information to the controller 202. At this time, the object may include various objects related to the driving of the vehicle 100, such as a lane, another vehicle, a pedestrian, a motorcycle, a traffic signal, a light, a road, a structure, a speed bump, a landmark, and an animal.

The object detector 204 is a plurality of sensor modules, and may include a camera module as a plurality of image capturers, a light imaging detection and ranging (LIDAR) device, an ultrasonic sensor, a radio detection and ranging (radar) 1450, and an infrared sensor.

The object detector 204 may sense environmental information around the vehicle 100 through a plurality of sensor modules.

In some implementations, the object detector 204 may further include components other than the components described, or may not include some of the components described.

The radar may include an electromagnetic wave transmitting module and an electromagnetic wave receiving module. The radar may be implemented by a pulse radar system or a continuous wave radar system in terms of the radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) scheme or a phase-shift scheme by using an electromagnetic wave as a medium, and may detect the position of the detected object, the distance to the detected object, and a relative speed of the detected object.

The radar may be disposed at an appropriate location outside the vehicle for sensing an object disposed at the front, back, or side of the vehicle.

The LIDAR may include a laser transmitting module and a laser receiving module. The LIDAR may be implemented in a TOF scheme or a phase-shift scheme.

The LIDAR may be implemented as a driven type or a non-driven type.

When implemented as a driven type, the LIDAR may be rotated by the motor, and is capable of detecting objects around the vehicle 100, and when implemented as a non-driven type, the LIDAR may detect objects located within a predetermined range on the basis of the vehicle 100. The vehicle 100 may include a plurality of non-driven type LIDARs.

The LIDAR may detect an object based on a TOF scheme or a phase-shift scheme by using a laser beam as a medium, and may detect the position of the detected object, the distance to the detected object, and the relative speed of the detected object.

The LIDAR may be disposed at an appropriate location outside the vehicle for sensing an object disposed at the front, back, or side of the vehicle.

The image capturer may be disposed at a suitable place outside the vehicle, for example, the front, back, right side mirrors and the left side mirror of the vehicle, in order to acquire a vehicle exterior image. The image acquirer may be a mono camera, but is not limited thereto, and may be a stereo camera, an around view monitoring (AVM) camera, or a 360 degree camera.

The image capturer may be disposed close to the front windshield in the interior of the vehicle in order to acquire an image of the front of the vehicle. Alternatively, the image capturer may be disposed around a front bumper or a radiator grill.

The image capturer may be disposed close to the rear glass in the interior of the vehicle in order to acquire an image of the back of the vehicle. The image capturer may be disposed around the rear bumper, the trunk, or the tail gate.

The image capturer may be disposed close to at least one side window in the vehicle in order to obtain an image of the side of the vehicle. In addition, the image capturer may be disposed around the fender or door.

The image capturer may provide the acquired image to the controller 202.

The ultrasonic sensor may include an ultrasonic transmission module and an ultrasonic reception module. The ultrasonic sensor can detect an object based on ultrasonic waves, and can detect the position of the detected object, the distance to the detected object, and the relative speed of the detected object.

The ultrasonic sensor may be disposed at an appropriate position outside the vehicle for sensing an object at the front, back, or side of the vehicle.

The infrared sensor may include an infrared transmission module and an infrared reception module. The infrared sensor can detect an object based on the infrared light, and can detect the position of the detected object, the distance to the detected object, and the relative speed of the detected object.

The infrared sensor may be disposed at an appropriate location outside the vehicle in order to sense objects located at the front, rear, or side portions of the vehicle.

The controller 202 may control the overall operation of the object detector 204.

The controller 202 may compare data sensed by the radar, the LIDAR, the ultrasonic sensor, and the infrared sensor with pre-stored data so as to detect or classify an object.

The controller 202 may detect and track objects based on the acquired image. The controller 202 may perform operations such as calculating a distance to an object and calculating a relative speed with respect to the object through an image processing algorithm.

For example, the controller 202 may acquire information on the distance to the object and information on the relative speed with respect to the object on the basis of variation of the object size with time in the acquired image.

For example, the controller 202 may obtain information on the distance to the object and information on the relative speed through, for example, a pin hole model and road surface profiling.

The controller 202 may detect and track the object based on the reflected electromagnetic wave that is reflected by the object and returned to the object after being transmitted. The controller 202 may perform operations such as calculating a distance to an object and calculating a relative speed of the object based on the electromagnetic wave.

The controller 202 may detect and track the object based on the reflected laser beam that is reflected by the object and returned to the object after being transmitted. The controller 202 may perform operations such as calculating a distance to an object and calculating a relative speed of the object based on the laser beam.

The controller 202 may detect and track the object based on the reflected ultrasonic wave that is reflected by the object and returned to the object after being transmitted. The controller 202 may perform operations such as calculating a distance to an object and calculating a relative speed of the object based on the ultrasonic wave.

The controller 202 may detect and track the object based on the reflected infrared light that is reflected by the object and returned to the object after being transmitted. The controller 202 may perform operations such as calculating a distance to an object and calculating a relative speed of the object based on the infrared light.

In some implementations, the object detector 204 may include a separate processor from the controller 202. In addition, each of the radar, the LIDAR, the ultrasonic sensor, and the infrared sensor may include a processor.

When a processor is included in the object detector 204, the object detector 204 may be operated under the control of the processor controlled by the controller 202.

The driving controller 205 may receive a user input for driving. In the case of the manual mode, the vehicle 100 may operate based on the signal provided by the driving controller 205.

The vehicle driver 206 may electrically control the driving of various apparatuses in the vehicle 100. The vehicle driver 206 may electrically control driving of a power train, a chassis, a door/window, a safety device, a lamp, and an air conditioner in the vehicle 100.

The operator 207 may control various operations of the vehicle 100. The operator 207 may be operated in an autonomous mode.

The operator 207 may include a driving module, an unparking module, and a parking module.

In some implementations, the operator 207 may further include constituent elements other than the constituent elements to be described, or may not include some of the constitute elements.

The operator 207 may include a processor under the control of the controller 202. Each module of the operator 207 may include a processor individually.

In some implementations, when the operator 207 is implemented as software, it may be a sub-concept of the controller 202.

The driving module may perform driving of the vehicle 100.

The driving module may receive object information from the object detector 204, and provide a control signal to a vehicle driving module to perform the driving of the vehicle 100.

The driving module may receive a signal from an external device via the transceiver 201, and provide a control signal to the vehicle driving module to perform the driving of the vehicle 100.

The unparking module may perform unparking of the vehicle 100.

The unparking module may receive navigation information from the navigation module, and provide a control signal to the vehicle driving module to perform the departure of the vehicle 100.

In the unparking module, object information may be received from the object detector 204, and a control signal may be provided to the vehicle driving module, so that the unparking of the vehicle 100 may be performed.

The unparking module may receive a signal from an external device via the transceiver 201, and provide a control signal to the vehicle driving module to perform the unparking of the vehicle 100.

The parking module may perform parking of the vehicle 100.

The parking module may receive navigation information from the navigation module, and provide a control signal to the vehicle driving module to perform the parking of the vehicle 100.

In the parking module, object information may be provided from the object detector 204, and a control signal may be provided to the vehicle driving module, so that the parking of the vehicle 100 may be performed.

The parking module may receive a signal from an external device via the transceiver 201, and provide a control signal to the vehicle driving module so as to perform the parking of the vehicle 100.

The navigation module may provide the navigation information to the controller 202. The navigation information may include at least one of map information, set destination information, route information according to destination setting, information about various objects on the route, lane information, or current location information of the vehicle.

The navigation module may provide the controller 202 with a parking lot map of the parking lot entered by the vehicle 100. When the vehicle 100 enters the parking lot, the controller 202 receives the parking lot map from the navigation module, and projects the calculated route and fixed identification information on the provided parking lot map so as to generate the map data.

The navigation module may include a memory. The memory may store navigation information. The navigation information may be updated by the information received through the transceiver 201. The navigation module may be controlled by a built-in processor, or may be operated by receiving an external signal, for example, a control signal from the controller 202, but the present disclosure is not limited to this example.

The driving module of the operator 207 may be provided with the navigation information from the navigation module, and may provide a control signal to the vehicle driving module so that driving of the vehicle 100 may be performed.

The sensor 208 may sense the state of the vehicle 100 using a sensor mounted on the vehicle 100, that is, a signal related to the state of the vehicle 100, and obtain movement route information of the vehicle 100 according to the sensed signal. The sensor 208 may provide the obtained movement route information to the controller 202.

The sensor 208 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 208 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 208 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS).

The sensor 208 may generate vehicle state information based on sensing data. The vehicle status information may be information generated based on data sensed by various sensors provided in the vehicle.

Vehicle state information may include information such as attitude information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, interior temperature information of the vehicle, interior humidity information of the vehicle, pedal position information, and vehicle engine temperature information.

The storage 209 is electrically connected to the controller 202. The storage 209 may store basic data for each unit of the vehicle collision avoidance apparatus 210, control data for operation control of each unit of the vehicle collision avoidance apparatus 210, and input/output data. The storage 209 may be various storage devices such as a ROM, a RAM, an EPROM, a flash drive, and a hard drive, in terms of hardware. The storage 209 may store various data for overall operation of the vehicle 100, such as a program for processing or controlling the controller 202, in particular driver propensity information. Here, the storage 209 may be formed integrally with the controller 202 or may be implemented as a sub-component of the controller 202.

The vehicle collision avoidance apparatus 210 may quickly recognize an object in the surrounding environment of the vehicle 100 by using a LIDAR and a camera installed in the vehicle 100. The vehicle collision avoidance apparatus 210 may determine that an object is a potentially threatening object and is a set avoidance target, and may control the vehicle 100 to avoid collision with the potentially threatening object in response to a determination that the vehicle 100 will collide with the potentially threatening object.

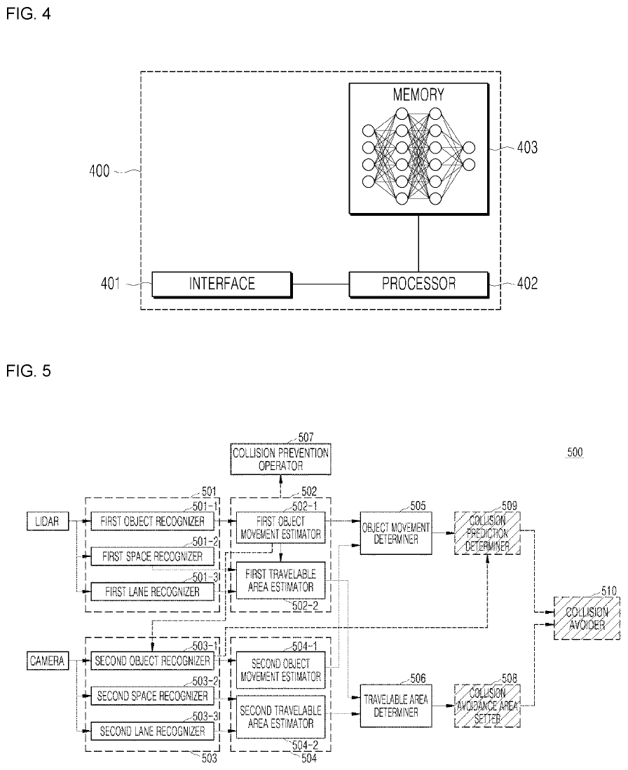

The vehicle collision avoidance apparatus 210 may include an interface, a processor, and a memory, which will be described in detail below with reference to FIG. 4. For example, the interface may be included in the transceiver 201, the processor may be included in the controller 202, and the memory may be included in the storage 209.

FIG. 4 is a diagram illustrating an example of a configuration of the vehicle collision avoidance apparatus.

Referring to FIG. 4, a vehicle collision avoidance apparatus 400 may include an interface 401, a processor 402, and a memory 403.

The interface 401 may receive a point cloud map of the surrounding environment in a set range from a LIDAR installed in a vehicle at set intervals. The interface 401 may receive an image of the surrounding environment from a camera installed in the vehicle at the set intervals. Here, the surrounding environment may be the environment of a traveling direction of the vehicle, but is not limited thereto, and may be the environment of all directions with respect to the vehicle.

In addition, the interface 401 may receive a high definition map (HD Map) from a server. Here, the HD Map may be a detailed map of an area including the surrounding environment of the set range or an area (for example, a district or a neighborhood) in which the vehicle is located.

Upon recognition of an object in the point cloud map, the processor 402 may determine whether the object is a potentially threatening object which can threaten the vehicle, thus determining whether a potentially threatening object is present in the point cloud map.

In response to determining that a potentially threatening object that is likely to threaten the vehicle is present in the point cloud map, the processor 402 may (i) activate an avoidance traveling algorithm to allow the vehicle to improve the collision avoidance response speed in preparation of the possibility of collision of the vehicle with the potentially threatening object, thereby preventing the collision in advance, or minimize damage caused by a collision that does occur. In this case, the processor 402 may, for example, cause the vehicle to perform a collision prevention operation by decelerating, accelerating, or steering the vehicle.

Thereafter, the processor 402 may (ii) set a collision avoidance space for avoiding the potentially threatening objects according to the activated avoidance traveling algorithm, and (iii) identify a type of the potentially threatening object in a region of interest (ROI) in the image corresponding to the position of the potentially threatening object, and determine that the type of the potentially threatening object is a set avoidance target (for example, a vehicle or a person). The processor 402 may move the vehicle to the collision avoidance space set in advance in response to a determination that the type of the potentially threatening object is a set avoidance target.

In addition, the processor 402 may further determine whether the vehicle will collide with the potentially threatening object, and in response to a determination that the vehicle will collide with the potentially threatening object, the processor 402 may move the vehicle to the collision avoidance space, thereby allowing the vehicle to avoid the collision with the potentially threatening object.

As a result, the processor 402 initially performs the collision prevention operation by activating the avoidance traveling algorithm based on the point cloud map received from the LIDAR, and then secondarily moves the vehicle to the collision avoidance space set in advance based on the image received from the camera, thereby allowing the vehicle to quickly avoid the collision with the potentially threatening object.

Upon determining the presence of the potentially threatening object, the processor 402 may first transform each of the point cloud maps received from the LIDAR at the set intervals from a three-dimensional point cloud map to a two-dimensional occupancy grid map (OGM). In this case, the processor 402 removes unnecessary parts (for example, the road surface and noise) from the three-dimensional point cloud map so as to reduce the amount of data for later object recognition and space recognition, thereby saving resources used for computation. In the point cloud map from which the unnecessary parts have been removed, the processor 402 may classify an area as an occupied area in which an object is estimated to be present or a non-occupied area in which no object is estimated to be present. Thereafter, the processor 402 may transform the three-dimensional point cloud map to the two-dimensional occupancy grid map based on the occupied and non-occupied areas.

Therefore, the two-dimensional occupancy grid map may also include the occupied area in which an object is estimated to be present and the non-occupied area in which no object is estimated to be present.

The processor 402 may check the movement of the occupied area in which an object is estimated to be present in each occupancy grid map, as a result of comparing each of the transformed occupancy grid maps (a plurality of occupancy grid maps). The processor 402 may check information on an object corresponding to the occupied area based on the movement, and determine whether the object is a potentially threatening object based on the information on the object. Here, the information on the object may include at least one of a speed of the object, a traveling direction of the object, a size of the object, or a distance between the object and the vehicle. In this case, the processor 402 may check the information on the object using, for example, a Kalman filter in the occupied area.

In detail, the processor 402 may compare a first occupancy grid map transformed from a first point cloud map that was received a set period (for example, 0.1 seconds) before the current time point, with a second occupancy grid map transformed from a second point cloud map received at the current time point. As a result of the comparison, the processor 402 may then determine whether the object estimated to be present in the occupied area is a potentially threatening object depending on whether the movement (or size or distance) of the occupied area in which the object is estimated to be present satisfies a set condition (for example, movement speed, direction, and size). That is, the processor 402 may determine that the object estimated to be present in the occupied area is a potentially threatening object in response to the movement (or size or distance) of the occupied area in which the object is estimated to be present satisfying the set condition.

For example, in response to an object estimated to be present in a first occupied area in the first occupancy grid map moving to a second occupied area in the second occupancy grid map, the processor 402 may determine that the object is a potentially threatening object based on the object being larger than a set size and moving toward the vehicle including the vehicle collision avoidance apparatus at above a set speed, and on the distance between the object and the vehicle being shorter than a set separation distance. In this case, the processor 402 may calculate the speed of the object based on the period in which the three-dimensional point cloud map is received and the moving distance between the first and second occupied areas.

In some implementations, the processor 402 may estimate (or predict) the movement of the object based on the information on the object. Here, the processor 402 may check whether the movement of the object is normal based on the lane information in the HD Map received from the server through the interface 401, and re-determine whether the object is a potentially threatening object based on the checked result. In this case, the processor 402 may transform the HD Map into a two-dimensional occupancy grid map, check whether the movement of the object is normal based on lane information within the occupancy grid map transformed from the HD Map, and in response to the movement of the object not being normal as a result of the checking, determining that the object is a potentially threatening object. For example, when the object estimated to be present in the occupied area disregards the lane information and quickly approaches the position of the vehicle including the vehicle collision avoidance apparatus, the processor 402 determines that the movement of the object is abnormal, and thereby determines that the object is a threatening object.

By contrast, in response to the movement of the object being normal as a result of checking, the processor 402 may determine that the object is not a potentially threatening object. For example, even when an object estimated to be present in the occupied area quickly approaches the position of the vehicle including the vehicle collision avoidance apparatus, in response to a prediction that the object is entering an adjacent lane based on the lane information, the processor 402 may determine that the movement of the object is normal, and thereby determine that the object is a non-threatening object that is unlikely to threaten the vehicle.

When the collision prevention operation of the vehicle is performed, the processor 402 may further check the distance between the potentially threatening object and the vehicle, in addition to the presence of the potentially threatening object in the point cloud map, and as the checked result, may control the vehicle to perform the collision prevention operation based on the distance being longer than a set braking distance of the vehicle.

In addition, when determining whether the type of the potentially threatening object is an avoidance target, the processor 402 may set an area corresponding to the spatial coordinates of the potentially threatening object in the image received from the camera through the interface 401 as a region of interest in response to a determination that the potentially threatening object is present in the point cloud map generated by the LIDAR, and identify the type of the potentially threatening object present in the set region of interest. In this case, the processor 402 may identify the type of the potentially threatening object by setting the region of interest in an image received simultaneously with the point cloud map in which it has been determined that the potentially threatening object is present (for example, an image received at the same period as the point cloud map, or an image received later than the point cloud map by a set period), and may then apply an object identification algorithm stored in the memory 403 to the image of the region of interest. Here, the object identification algorithm may be a neural network model trained to detect an object in a designated area in a collected image and identify the type of the detected object.

That is, the processor 402 may set the position of the object determined to be the potentially threatening object in the point cloud map generated by the LIDAR as the region of interest in the image generated by the camera, and thereby quickly recognize the object within the region of interest. Accordingly, the processor 402 can quickly and easily recognize the information on the potentially threatening object (for example, the position, type, size, and form of the potentially threatening object), using the LIDAR that is capable of quickly and accurately estimating the position of the object and the camera that is capable of quickly and accurately estimating the type (or form or size) of the object.

Furthermore, in response to a determination that the potentially threatening object is present in the point cloud map (or in response to the region of interest being set in the image), the processor 402 may increase a frame rate by a set multiple (or a set numerical value) when the camera photographs the region of interest, and by the increased amount of the frame rate may increase the number of times of identifying the type of the potentially threatening object in the region of interest within each image received through the interface 401. Accordingly, the accuracy of recognizing the type of potentially threatening object can be increased to above a set reliability. For example, in a state in which the point cloud map and the image are each received every 0.1 seconds, in response to a determination that the potentially threatening object is present in the point cloud map, the processor 402 may increase the frame rate when the camera photographs the region of interest such that an image is received every 0.05 seconds. Accordingly, the potentially threatening object in the region of interest is identified in two images during the same time (0.1 seconds), thus increasing the number of times of identifying the type of the potentially threatening object twofold.

In addition, in response to a determination that the potentially threatening object is present in the point cloud map (or in response to the region of interest being set in the image), the processor 402 may receive a larger amount of data (point cloud maps and images) by reducing the period at which the point cloud map generated by the LIDAR and the image generated by the camera are generated, thereby providing an environment in which the change in the surrounding environment may be understood more quickly.

When determining whether the vehicle and the potentially threatening object will collide, the processor 402 may check the distance between the potentially threatening object and the vehicle, and, as a result of the checking, determine that the vehicle will collide with the potentially threatening object based on the distance between the potentially threatening object and the vehicle being shorter than the set braking distance of the vehicle, and move the vehicle to the collision avoidance space.

In addition, the processor 402 may determine a travelable area of the vehicle from the point cloud map and the image. In this case, the processor 402 may determine the travelable area of the vehicle based on a non-occupied area in which it is estimated from the two-dimensional occupancy grid map transformed from the three-dimensional point cloud map that no object is present, and on the movement of the object. The processor 402 may adjust the travelable area of the determined vehicle based on the travelable area in the image, and control the traveling of the vehicle based on the adjusted travelable area. In this case, the processor 402 may recognize, for example, travelable areas of the vehicle excluding the object from the point cloud map and the image, respectively, and among the respective recognized travelable areas of the vehicle, the processor 402 may determine only an area for which the point cloud map and the image match each other as the travelable area of the vehicle.

When setting the collision avoidance space, the processor 402 may set, among the non-travelable areas of the vehicle, an avoidance area according to a set condition (for example, a crosswalk or a sidewalk where no person is present), and may set the set avoidance area and the travelable area of the vehicle as the collision avoidance space. In other words, the processor 402 may determine a situation in which a collision between the vehicle and the potentially threatening object is predicted as an emergency situation, and in the emergency situation may temporarily set as a collision avoidance space not only a travelable area but also an area that in a non-emergency situation is a non-travelable area. In this case, when performing the collision prevention operation in the vehicle, the processor 402 may, for example, set the collision avoidance space in advance or set the collision avoidance space every set period, thereby quickly moving the vehicle the set collision avoidance space upon determination that the vehicle will collide with the potentially threatening object.

When controlling the vehicle to avoid the collision between the vehicle and the potentially threatening object, the processor 402 may move the vehicle to the set collision avoidance space, but before the moving the vehicle to the set collision avoidance space may transmit a message on the movement of the vehicle to the collision avoidance space to another vehicle located within a set range with respect to the vehicle, thereby allowing the other vehicle to recognize the moving position of the vehicle in advance so as to prevent collision between the vehicle and the other vehicle.

Furthermore, the processor 402 may deactivate the avoidance traveling algorithm in response to a determination that the type of the potentially threatening object is not the set avoidance target or that the vehicle will not collide with the potentially threatening object, thereby reducing energy consumed by the avoidance traveling algorithm.

The memory 403 may store an object identification algorithm, which is a neural network model trained to detect objects in a designated area in an image collected in advance and identify a type of the detected object.

The memory 403 may perform a function of temporarily or permanently storing data processed by the processor 402. Here, the memory 403 may include a magnetic storage medium or a flash storage medium, but the scope of the present disclosure is not limited thereto. The memory 403 may include an internal memory and/or an external memory and may include a volatile memory such as a DRAM, a SRAM or a SDRAM, and a non-volatile memory such as one-time programmable ROM (OTPROM), a PROM, an EPROM, an EEPROM, a mask ROM, a flash ROM, a NAND flash memory or a NOR flash memory, a flash drive such as an SSD, a compact flash (CF) card, an SD card, a Micro-SD card, a Mini-SD card, an XD card or memory stick, or a storage device such as a HDD.

FIG. 5 is a diagram illustrating another example of the configuration of the vehicle collision avoidance apparatus.

Referring to FIG. 5, a vehicle collision avoidance apparatus 500 may be included in a vehicle, and may include a first recognizer 501, a first estimator 502, a second recognizer 503, a second estimator 504, an object movement determiner 505, a travelable area determiner 506, a collision prevention operator 507, a collision avoidance area setter 508, a collision prediction determiner 509, and a collision avoider 510. Here, each component in the vehicle collision avoidance apparatus 500 may correspond to the processor of FIG. 4. In some examples, a processor or controller (e.g., controller 202) may include one or more of the components in FIG. 5. In some examples, the components in FIG. 5 may be software modules configured to be executed by the processor or controller.

The first recognizer 501 may receive a point cloud map of the surrounding environment from a LIDAR installed in the vehicle at the set intervals. Upon receiving the point cloud map, the first recognizer 501 may recognize, from the point cloud map, at least one of information on an object, spatial information, or lane information. The first recognizer 501 may include a first object recognizer 501-1, a first space recognizer 501-2, and a first lane recognizer 501-3. Here, the first object recognizer 501-1 may recognize the object from the point cloud map, and recognize information on the object (for example, information on at least one of a speed of the object, a traveling direction of the object, a size of the object, or a distance between the object and the vehicle) from the plurality of point cloud maps received at the set intervals. The first space recognizer 501-2 may recognize the spatial information from the point cloud map. In addition, the first lane recognizer 501-3 may recognize the lane information from the point cloud map.

The first estimator 502 may receive, from the first recognizer 501, at least one of the information on the object, the spatial information, or the lane information, and estimate at least one of the movement or the travelable area of the object based on the received information. The first estimator 502 may include a first object movement estimator 502-1 and a first travelable area estimator 502-2. Here, the first object movement estimator 502-1 may receive the information on the object from the first object recognizer 501-1, and estimate the movement of the object based on the received information on the object. In this case, the first object movement estimator 502-1 may determine whether the object recognized from the point cloud map generated by the LIDAR is a potentially threatening object that is likely to threaten the vehicle based on the movement of the object. For example, the first object movement estimator 502-1 may determine that the object is a potentially threatening object based on the object being larger than a set size and moving toward the vehicle at above a set speed, and on the distance between the object and the vehicle being shorter than a set separation distance.

In some implementations, in response to a determination that the object is a potentially threatening object, the first object movement estimator 502-1 may provide an environment in which the type of the object can be quickly identified by transmitting the spatial coordinates of the potentially threatening object to the second object recognizer 503-1.

The first travelable area estimator 502-2 may receive the spatial information from the first space recognizer 501-2, receive the lane information from the first lane recognizer 501-3, and estimate the travelable area of the vehicle based on the received spatial information and lane information. In addition, the first travelable area estimator 502-2 may further receive the information on the object (or the movement of the object) from the first object movement estimator 502-1, and may estimate the travelable area of the vehicle further based on the information on the object (or the movement of the object) along with the spatial information and the lane information.

The second recognizer 503 may receive an image of the surrounding environment from a camera installed in the vehicle at the set intervals. Upon receiving the image, the second recognizer 503 may recognize at least one of the information on the object, the spatial information, or the lane information from the image. The second recognizer 503 may include a second object recognizer 503-1, a second space recognizer 503-2, and a third lane recognizer 503-3. Here, the second object recognizer 503-1 may recognize the object from the image, and recognize the information on the object (for example, information on at least one of the speed of the object, the traveling direction of the object, the size of the object, or the distance between the object and the vehicle) from the plurality of images received at the set intervals.

In some implementations, upon receiving the spatial coordinates for the potentially threatening object from the first object movement estimator 502-1, the second object recognizer 503-1 may set an area corresponding to the spatial coordinates in the image as a region of interest (ROI), and may quickly identify the type of the potentially threatening object in the set region of interest and provide the identified type of the potentially threatening object to the collision prediction determiner 509, such that the collision prediction determiner 509 may quickly determine whether the object will collide with the vehicle.

The second space recognizer 503-2 may recognize the spatial information from the image. In addition, the second lane recognizer 503-3 may recognize the lane information from the image.

The second estimator 504 may receive at least one of the information on the object, the spatial information, or the lane information from the second recognizer 503, and estimate at least one of the movement or the travelable area of the object based on the received information. The second estimator 504 may include a second object movement estimator 504-1 and a second travelable area estimator 504-2. Here, the second object movement estimator 504-1 may receive the information on the object from the second object recognizer 503-1, and estimate the movement of the object based on the received information on the object. The second travelable area estimator 504-2 may receive the spatial information from the second space recognizer 503-2, receive the lane information from the second lane recognizer 503-3, and estimate the travelable area of the vehicle based on the received spatial information and lane information.

The object movement determiner 505 may receive the movement of the object estimated from the first object movement estimator 502-1, receive the movement of the object estimated from the second object movement estimator 504-1, and determine the movement of the object based on each of the received movements of the object. In this case, for example, the object movement determiner 505 may determine, as the movement of the object, only a movement for which the respective estimated movements of the object match each other, and predict the future movement of the object (for example, the direction in which the object intends to move, or the speed of the object) based on the determined movement of the object.

The travelable area determiner 506 may receive the estimated travelable area of the vehicle from the first travelable area estimator 502-2, receive the estimated travelable area of the vehicle from the second travelable area estimator 504-2, and determine the travelable area of the vehicle based on each of the received travelable areas of the vehicle. In this case, for example, the travelable area determiner 506 may determine, as the travelable area of the vehicle, only an area for which the respective estimated travelable areas of the vehicle match each other.

The collision prevention operator 507 may activate the avoidance traveling algorithm in response to the first object movement estimator 502-1 identifying the object recognized from the point cloud map generated by the LIDAR as the potentially threatening object, and accordingly, may cause the vehicle to perform the collision prevention operation in preparation of the possibility of collision of the vehicle with the potentially threatening object. In this case, the collision prevention operator 507 may cause the vehicle to perform the collision prevention operation by decelerating, accelerating, or steering the vehicle.

The collision avoidance area setter 508 may set, among the non-travelable areas of the vehicle, an avoidance area according to a set condition (for example, a crosswalk or a sidewalk where no person is present), and may set the set avoidance area as the collision avoidance space along with the travelable area of the vehicle determined by the travelable area determiner 506.

The collision prediction determiner 509 may determine that the vehicle will collide with the potentially threatening object based on the second object recognizer 503-1 identifying the type of the potentially threatening object detected from the image generated by the camera and determining that the type of the potentially threatening object is the set avoidance target, and determining that the distance between the potentially threatening object and the vehicle is shorter than the set braking distance of the vehicle.

In response to a determination by the collision prediction determiner 509 that the vehicle will collide with the potentially threatening object, the collision avoider 510 may move the vehicle performing the collision prevention operation to the collision avoidance space that is set in advance by the collision avoidance area setter 508, thereby quickly moving the vehicle to a safe place at which collision with the potentially threatening object is unlikely.

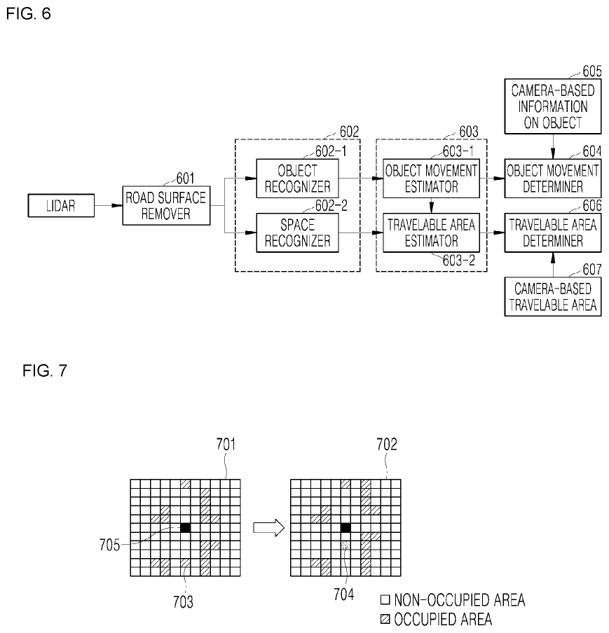

FIG. 6 is a diagram illustrating an example of a configuration of determining a movement and a travelable area of an object using a LIDAR in the vehicle collision avoidance apparatus.

Referring to FIG. 6, the vehicle collision avoidance apparatus 600 includes a road surface remover 601, a recognizer 602, an estimator 603, an object movement determiner 604, and a travelable area determiner 606.

The road surface remover 601 may receive a point cloud map of the surrounding environment from a LIDAR installed in a vehicle at the set intervals. At this time, the road surface remover 601 may remove unnecessary portions (for example, the road surface (road) and noise) from the point cloud map, thereby saving resources used for computation by reducing the amount of data for later object recognition and space recognition.

The road surface remover 601 may use, for example, an algorithm such as an elevation map, and may measure a height for each cell in a bird's eye view space, and may regard an area in which the measured values continuously change as a road surface and regard an area in which the measured values discontinuously change as an object area.

The recognizer 602 may receive the point cloud map from which the road surface (road) and noise have been removed, and estimate the information on the object and the spatial information from the received point cloud map. The recognizer 602 may include an object recognizer 602-1 and a space recognizer 602-2.

The object recognizer 602-1 may recognize the object from the point cloud map from which the road surface (road) and the noise have been removed, and recognize the information on the object (for example, information on at least one of a probability of the object, a speed of the object, a traveling direction of the object, a size of the object, or a distance between the object and the vehicle) from the plurality of point cloud maps received at the set intervals. In this case, the object recognizer 602-1 may perform three-dimensional distance-based clustering on the point cloud map to recognize the information on the object. The object recognizer 602-1 may recognize the object using a deep neural network (DNN) algorithm that is pre-trained to recognize an object from a point cloud map.

From the point cloud map from which the road surface (road) and the noise have been removed, the space recognizer 602-2 may calculate a probability of the bird's eye view-based space and an empty space in addition to the bird's eye view-based space. In this case, the space recognizer 602-2 may use, for example, an occupancy grid map (OGM) for space recognition, and by using data in the height direction may recognize the space as an occupied area when the height is higher than a predetermined level and may recognize the space as a non-occupied area when the height is less than the predetermined level.

The estimator 603 may include an object movement estimator 603-1 and a travelable area estimator 603-2.

The object movement estimator 603-1 may receive the information on the object from the object recognizer 602-1, and estimate the movement of the object based on the received information on the object. In this case, the object movement estimator 603-1 may estimate a predicted path of the object based on the estimated object movement. Here, the object movement estimator 603-1 may estimate future data based on past and present data using, for example, a Kalman filter.

The travelable area estimator 603-2 may estimate the travelable area of the vehicle based on the bird's eye view-based occupied area received from the space recognizer 602-2 and on the information on the object (or the movement of the object) received from the object movement estimator 603-1.

The object movement determiner 604 may receive the estimated movement of the object estimated from the object movement estimator 603-1 or the predicted path of the estimated object, and receive camera-based information 605 on an object from the object movement estimator associated with the camera. In this case, the object movement determiner 604 may determine information on one object by fusing LIDAR-based information on the object and camera-based information on the object. Here, the object movement determiner 604 may further improve the accuracy of the position of the object and the distance between the vehicle and the object by assigning a weight to the position of the object and the distance between the vehicle and the object among the information on the object acquired through the LIDAR, and further improve the accuracy of recognizing the type, form, and size of the object by assigning a weight to the type, form, and size of the object among the information on the object acquired through the camera. Accordingly, the advantages of both the LIDAR and the camera can be used.

The travelable area determiner 606 may receive an estimated travelable area 607 of the vehicle from the travelable area estimator associated with the camera, and receive the camera-based travelable area from the travelable area estimator associated with the camera. In this case, the travelable area determiner 606 may fuse the LIDAR-based travelable area of the vehicle and the camera-based travelable area of the vehicle so as to determine the travelable area of one vehicle. Here, the travelable area determiner 606 may assign a weight to the position of the travelable area of the vehicle and the distance between the vehicle and the travelable area that are acquired through the LIDAR, thereby more accurately acquiring the position of the travelable area of the vehicle and the distance between the vehicle and the travelable area.

FIG. 7 is a diagram illustrating an example of identifying a potentially threatening object in the vehicle collision avoidance apparatus.

Referring to FIG. 7, the vehicle collision avoidance apparatus in a vehicle may transform each of the point cloud maps received from the LIDAR at set intervals from a three-dimensional point cloud map to a two-dimensional occupancy grid map (OGM). Here, the two-dimensional occupancy grid map may include an occupied area in which an object is estimated to be present and a non-occupied area in which no object is estimated to be present.

In this case, the vehicle collision avoidance apparatus may check the information on the object corresponding to the occupied area including at least one of the speed of the object, the traveling direction of the object, the size of the object, or the distance between the object and the vehicle, based on movement of the occupied area in which the object is estimated to be present in each of the transformed occupancy grid maps, and determine that the object is a potentially threatening object based on the movement of the object according to the information on the object. For example, the vehicle collision avoidance apparatus may compare a first occupancy grid map 701 transformed from a first point cloud map that was received a set period (for example, 0.1 seconds) before the current time point, with a second occupancy grid map 702 transformed from a second point cloud map received at the current time point. As a result of the comparison, the vehicle collision avoidance apparatus may determine whether the object estimated to be present in the occupied area 704 is a potentially threatening object depending on whether the movement (703→704) of the occupied area in which the object is estimated to be present satisfies a set condition (for example, movement speed, direction, and size). That is, the vehicle collision avoidance apparatus may determine that the object estimated to be present in the occupied area 704 is a potentially threatening object in response to the movement of the occupied area in which the object is estimated to be present satisfying the set condition.

For example, in response to the object estimated to be present in the first occupied area 703 moving to the second occupied area 704, the vehicle collision avoidance apparatus may determine that the object is a potentially threatening object based on the object moving toward a vehicle 705 including the vehicle collision avoidance apparatus at above a set speed, and on the distance between the object and the vehicle 705 being shorter than a set separation distance.

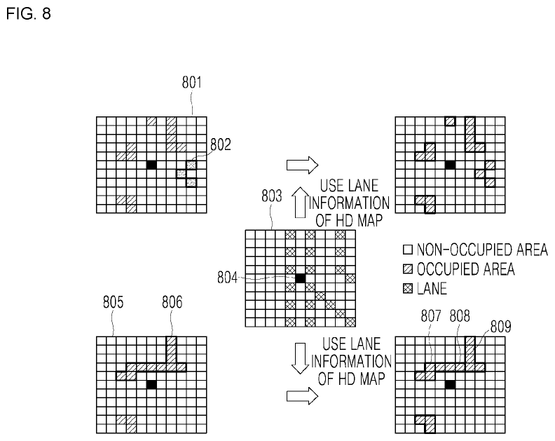

FIG. 8 is a diagram illustrating another example of checking the potentially threatening object in the vehicle collision avoidance apparatus.

Referring to FIG. 8, the vehicle collision avoidance apparatus in the vehicle may compare, for example, a first occupancy grid map transformed from a first point cloud map that was received a set period (for example, 0.1 seconds) before the current time point, with a second occupancy grid map transformed from a second point cloud map received at the current time point, and check whether the object is a potentially threatening object depending on whether the movement of the first occupancy grid map and the second occupancy grid map 801 of an occupied area 802 in which the object is estimated to be present satisfies a set condition (for example, movement speed, direction, and size). That is, the vehicle collision avoidance apparatus may determine that the object estimated to be present in the occupied area 802 is a potentially threatening object in response to the movement of the occupied area 802 in which the object is estimated to be present satisfying the set condition.

In some implementations, the vehicle collision avoidance apparatus may receive, for example, a high definition map (HD Map) from an artificial intelligence (AI) server, and may re-determine whether the object estimated to be present in the occupied area 802 is a potentially threatening object based on lane information in the HD Map. In this case, the vehicle collision avoidance apparatus may transform the HD Map into a two-dimensional occupancy grid map 803, check whether the movement of the object estimated to be present in the occupied area 802 is normal based on the occupancy grid map 803 transformed from the HD Map, and determine that the object is a potentially threatening object in response to the movement of the object not being normal as a result of the checking. By contrast, the vehicle collision avoidance apparatus may determine that the object is not a potentially threatening object in response to the movement of the object being normal as a result of the checking. For example, based on the lane information in the occupancy grid map 803 of the HD Map, the vehicle collision avoidance apparatus may determine that an object estimated to be present in the occupied area 802 is not entering a lane in which a vehicle 804 is travelling but rather is entering another lane located next to the lane in which the vehicle 804 is travelling, and thereby determine that the object is a general object that is unlikely to threaten the vehicle 804.

In addition, based on the occupancy grid map 803 of the HD Map, the vehicle collision avoidance apparatus may check the size of the object or the number of objects estimated to be present in an occupied area in a third occupancy grid map 805. For example, based on the occupancy grid map 803 of the HD Map, the vehicle collision avoidance apparatus may check the size of a first object 807, a second object 808, and a third object 809 estimated to be present in an occupied area 806 in the third occupancy grid map 805, and the number of objects (e.g., three).

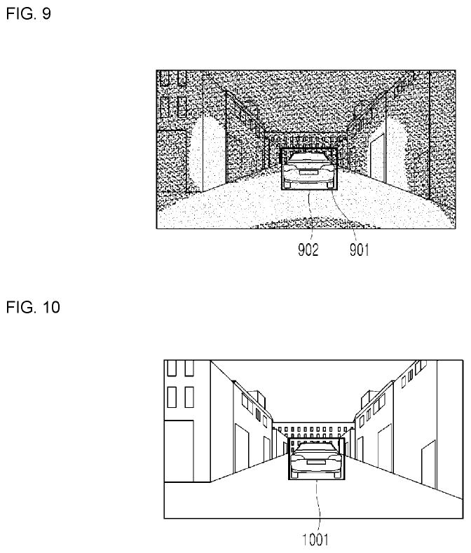

FIGS. 9 and 10 are diagrams illustrating an example processing method when the potentially threatening object in the vehicle collision avoidance apparatus is checked.

Referring to FIG. 9, the vehicle collision avoidance apparatus in the vehicle may transform each of the point cloud maps received from the LIDAR installed in the vehicle at set intervals from a three-dimensional point cloud map to a two-dimensional occupancy grid map, and may determine whether a potentially threatening object that is likely to threaten the vehicle is present within a set range with respect to the vehicle based on the difference between the plurality of occupancy grid maps.

In response to a determination that a potentially threatening object 901 is present, the vehicle collision avoidance apparatus may set an area corresponding to spatial coordinates 902 of the potentially threatening object as a region of interest 1001 in the image received from the camera installed in the vehicle, and identify a type of potentially threatening object 901 in the set region of interest 1001.

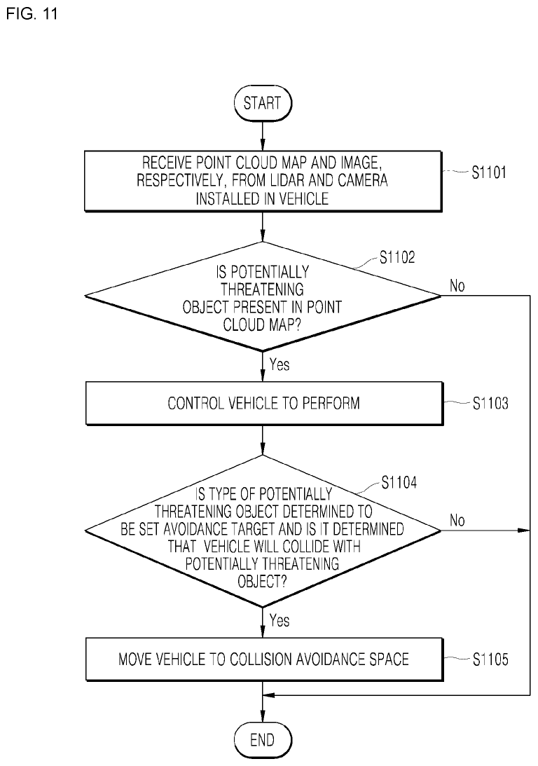

FIG. 11 is a flowchart illustrating an example of a vehicle collision avoidance method. Here, the vehicle collision avoidance apparatus implementing the vehicle collision avoidance method may generate an object identification algorithm and store the generated object identification algorithm in a memory. The object identification algorithm may be a neural network model trained to detect an object in a designated area in a collected image and identify the type of the detected object.

Referring to FIG. 11, in step S1101, the vehicle collision avoidance apparatus may receive, from a LIDAR installed in a vehicle, a point cloud map of a surrounding environment within a set range, and receive, from a camera installed in the vehicle, an image of the surrounding environment. In this case, the vehicle collision avoidance apparatus may receive the point cloud map and the image at set intervals.

In step S1102, the vehicle collision avoidance apparatus may determine whether a potentially threatening object that is likely to threaten the vehicle is present in the point cloud map.

Here, the vehicle collision avoidance apparatus may transform each of the point cloud maps received from the LIDAR from a three-dimensional point cloud map into a two-dimensional occupancy grid map, and as a result of comparing each of the transformed occupancy grid maps, may check movement of the occupied area in which the object is estimated to be present in each of the occupancy grid maps. The vehicle collision avoidance apparatus may check information on the object corresponding to the occupied area including at least one of a speed of the object, a traveling direction of the object, a size of the object, or a distance between the object and the vehicle, based on the movement, and determine that the object is a potentially threatening object based on the information on the object.

In some examples, the vehicle collision avoidance apparatus may determine that the object is the potentially threatening object based on the object being larger than a set size and moving toward the vehicle at above a set speed, and on the distance between the object and the vehicle being shorter than a set separation distance.

In some implementations, the vehicle collision avoidance apparatus may estimate the movement of the object based on the information on the object, and check whether the movement of the object is normal based on lane information in an HD Map received from the server. In this case, the vehicle collision avoidance apparatus may determine that the object is the potentially threatening object in response to the movement of the object not being normal as a result of the checking. For example, the vehicle collision avoidance apparatus may determine that the movement of the object is abnormal when the object estimated to be present in the occupied area disregards the lane information and quickly approaches the position of the vehicle including the vehicle collision avoidance apparatus, and thereby determine that the object is a threatening object.

In some implementations, the vehicle collision avoidance apparatus may determine that the object is not a potentially threatening object in response to the movement of the object being normal as a result of the checking. For example, even when an object quickly approaches the location of the vehicle including the vehicle collision avoidance apparatus, in response to a prediction that the object is entering an adjacent lane based on the lane information, the vehicle collision avoidance apparatus may determine that the movement of the object is normal, and thereby determine that the object is a non-threatening object that is unlikely to threaten the vehicle.

Upon the vehicle collision avoidance apparatus determining in step S1102 that a potentially threatening object that is likely to threaten the vehicle is present in the point cloud map, in step S1103 the vehicle collision avoidance apparatus may activate the avoidance traveling algorithm to control the vehicle to perform a collision prevention operation.

In this case, the vehicle collision avoidance apparatus may check the distance between the potentially threatening object and the vehicle, and cause the vehicle to perform the collision prevention operation by decelerating, accelerating, or steering the vehicle based on the distance being longer than a set braking distance of the vehicle, thereby preparing for the possibility of collision of the vehicle with the potentially threatening object. Further, the vehicle collision avoidance apparatus may set a collision avoidance space for avoiding the potentially threatening object according to the activated avoidance traveling algorithm. In this case, the vehicle collision avoidance apparatus may set, among the non-travelable areas of the vehicle, an avoidance area according to a set condition (for example, a crosswalk or a sidewalk where no person is present), and may set the set avoidance area and the travelable area of the vehicle as the collision avoidance space. That is, the vehicle collision avoidance apparatus may determine a situation in which a collision between the vehicle and the potentially threatening object is predicted as an emergency situation, and in the emergency situation may temporarily set as a collision avoidance space not only a travelable area but also an area that in a non-emergency situation is a non-travelable area.

In step S1104, the vehicle collision avoidance apparatus may identify the type of the potentially threatening object in a region of interest in the image corresponding to the location of the potentially threatening object, determine that the type of the potentially threatening object is a set avoidance target, and determine whether the vehicle will collide with the potentially threatening object. In this case, the vehicle collision avoidance apparatus may apply the object identification algorithm in the memory to the image of the region of interest, recognize the type of the potentially threatening object, and determine whether the recognized type of the potentially threatening object is the avoidance target.

In addition, the vehicle collision avoidance apparatus may check the distance between the potentially threatening object and the vehicle, and determine that the vehicle will collide with the potentially threatening object based on the distance being shorter than the set braking distance of the vehicle.

Upon the vehicle collision avoidance apparatus determining in step S1104 that the type of the potentially threatening object is a set avoidance target and that the vehicle will collide with the potentially threatening object, the vehicle collision avoidance apparatus may move the vehicle to the collision avoidance space in step S1105.

In addition, before moving the vehicle to the set collision avoidance space, the vehicle collision avoidance apparatus may transmit a message on the movement of the vehicle to the collision avoidance space to another vehicle located within a set range with respect to the vehicle, so as to allow the other vehicle to recognize the movement position of the vehicle in advance and thereby prevent collision between the vehicle and the other vehicle.

When setting the region of interest, in response to a determination that a potentially threatening object is present in the point cloud map, the vehicle collision avoidance apparatus may set an area corresponding to the spatial coordinates of the potentially threatening object in the image as the region of interest. In this case, the vehicle collision avoidance apparatus may increase a frame rate by a set multiple when the camera photographs the region of interest so as to increase the number of times of identifying the type of the potentially threatening object in the received image of the region of interest, thereby increasing the accuracy of recognizing the type of potentially threatening object above a set reliability.

Upon the vehicle collision avoidance apparatus determining in step S1104 that the type of the potentially threatening object is not the set avoidance target or that the vehicle will not collide with the potentially threatening object, the vehicle collision avoidance apparatus may deactivate the activated avoidance traveling algorithm, thereby reducing energy consumed by the avoidance traveling algorithm.

In addition, the vehicle collision avoidance apparatus may estimate the movement of the object based on the information on the object, and determine the travelable area of the vehicle based on a non-occupied area in which it is estimated from the occupancy grid map that no object is present, and on the movement of the object. The vehicle collision avoidance apparatus may adjust the determined travelable area of the vehicle based on the travelable area in the image received at the set intervals, and control the traveling of the vehicle based on the adjusted travelable area.

Implementations according to the present disclosure described above may be implemented in the form of computer programs that may be executed through various components on a computer, and such computer programs may be recorded in a computer-readable medium. Examples of the computer-readable medium may include, but are not limited to: magnetic media such as hard disks, floppy disks, and magnetic tapes; optical media such as CD-ROM disks and DVD-ROM disks; magneto-optical media such as floptical disks; and hardware devices that are specially configured to store and execute program commands, such as ROM, RAM, and flash memory devices.

In some implementations, the computer programs may be those specially designed and constructed for the purposes of the present disclosure or they may be of the kind well known and available to those skilled in the computer software arts. Examples of the computer programs may include both machine codes produced by a compiler, and higher level language code that may be executed by a computer using an interpreter.

As used in the present disclosure (especially in the appended claims), the singular forms “a,” “an,” and “the” include both singular and plural references, unless the context clearly states otherwise. In addition, the description of a range may include individual values falling within the range (unless otherwise specified), and is the same as describing the individual values forming the range.

The above-mentioned steps constructing the method disclosed in the present disclosure may be performed in a proper order unless explicitly stated otherwise. The present disclosure is not necessarily limited to the order of the steps given in the description. All examples described herein or the terms indicative thereof (“for example,” etc.) used herein are merely to describe the present disclosure in greater detail. Therefore, it should be understood that the scope of the present disclosure is not limited to the exemplary implementations described above or by the use of such terms unless limited by the appended claims. Also, it should be apparent to those skilled in the art that various modifications, combinations, and alternations can be made depending on design conditions and factors within the scope of the appended claims or equivalents thereof.

The present disclosure is thus not limited to the example implementations described above, and rather intended to include the following appended claims, and all modifications, equivalents, and alternatives falling within the spirit and scope of the following claims.

What is claimed is:

1. A vehicle collision avoidance apparatus, comprising:
an interface configured to:
receive, from a light detection and ranging device (LIDAR) installed at a vehicle, a point cloud map representing a surrounding environment within a set range from the LIDAR, and
receive, from a camera installed at the vehicle, an image of the surrounding environment; and
a processor configured to:
determine whether an object that is expected to collide with the vehicle is present in the point cloud map,
in response to a determination that the object is present in the point cloud map, activate an avoidance traveling process,
set a collision avoidance space defined to avoid the object according to the avoidance traveling process,
identify a type of the object based on a region of interest that is set according to a location of the object in the image,
based on identifying the type of the object, determine whether the type of the object corresponds to a set avoidance target, and
drive the vehicle to the collision avoidance space in response to a determination that the type of the object corresponds to the set avoidance target.

2. The vehicle collision avoidance apparatus of claim 1, wherein:
the point cloud map comprises a plurality of point could maps that are received from the LIDAR based on set intervals; and
the processor is configured to:
transform each point cloud map from a three-dimensional point cloud map to a two-dimensional occupancy grid map (OGM),
compare OGMs of the plurality of point could maps, each OGM comprising an occupied area in which one or more objects are expected to be present,
based on comparing the OGMs, determine movement of the one or more objects in the occupied area,
based on determining the movement of the one or more objects in the occupied area, determine object information corresponding to the one or more objects in the occupied area, the object information comprising at least one of a speed of the one or more objects, a traveling direction of the one or more objects, a size of the one or more objects, or a distance between the one or more objects and the vehicle, and
based on the object information, determine whether the one or more objects correspond to the object that is expected to collide with the vehicle.

3. The vehicle collision avoidance apparatus of claim 2, wherein the processor is configured to:
determine that the one or more objects correspond to the object that is expected to collide with the vehicle based on (i) the size of the one or more objects being greater than a set size, (ii) the speed of the one or more objects toward the vehicle being greater than a set speed, and (iii) the distance between the one or more objects and the vehicle being less than a set separation distance.

4. The vehicle collision avoidance apparatus of claim 2, wherein:
the interface is configured to receive a high definition (HD) map from a server, the HD map comprising lane information; and
the processor is configured to:
estimate movement of the one or more objects based on the object information,
determine whether the estimated movement of the one or more objects is normal according to the lane information in the HD map, and
based on a determination that the estimated movement of the one or more objects is abnormal, determine that the one or more objects correspond to the object that is expected to collide with the vehicle.

5. The vehicle collision avoidance apparatus of claim 2, wherein:
the interface is configured to receive a plurality of images from the camera at the set intervals;
each OGM further comprises a non-occupied area in which no object is expected to be present; and
the processor is configured to:
estimate movement of the one or more objects based on the object information,
based on the estimated movement of the one or more objects, determine a travelable area of the vehicle in the non-occupied area,
adjust the travelable area of the vehicle based on travelable areas determined from the plurality of images, and
control traveling of the vehicle based on the adjusted travelable area.

6. The vehicle collision avoidance apparatus of claim 1, wherein the processor is configured to:
before setting the collision avoidance space, cause the vehicle to perform a collision prevention operation by decelerating, accelerating, or steering the vehicle based on a distance between the object and the vehicle being greater than a set braking distance of the vehicle.

7. The vehicle collision avoidance apparatus of claim 1, wherein the processor is configured to:
determine that the vehicle is expected to collide with the object based on a distance between the object and the vehicle being less than a set braking distance of the vehicle; and
in response to a determination that the vehicle is expected to collide with the object, drive the vehicle to the collision avoidance space.

8. The vehicle collision avoidance apparatus of claim 1, wherein the processor is configured to:
set an avoidance area comprising non-travelable areas that the vehicle is not allowed to enter;
set the avoidance area and a travelable area of the vehicle as the collision avoidance space; and
drive the vehicle to the collision avoidance space to avoid a collision between the vehicle and the object.

9. The vehicle collision avoidance apparatus of claim 8, wherein the processor is configured to:
before driving the vehicle to the collision avoidance space, transmit a message about movement of the vehicle to the collision avoidance space to another vehicle located within a set range from the vehicle.

10. The vehicle collision avoidance apparatus of claim 1, wherein the processor is configured to:
in response to a determination that the object is present in the point cloud map, set an area corresponding to spatial coordinates of the object in the image as the region of interest;
increase a frame rate of the camera for capturing images of the region of interest; and
identify the type of the object based on the images captured at the frame rate.

11. The vehicle collision avoidance apparatus of claim 1, wherein the processor is configured to:
perform an object identification process with the image including the region of interest; and
based on performance of the object identification process, identify the type of the object and determine whether the type of the object corresponds to the set avoidance target, and
wherein the object identification process comprises a neural network model trained to detect a sample object in a sample image and identify a type of the sample object.

12. The vehicle collision avoidance apparatus of claim 1, wherein the processor is configured to deactivate the avoidance traveling process in response to (i) a determination that the type of the object does not correspond to the set avoidance target or (ii) a determination that the vehicle is not expected to collide with the object.

13. A vehicle collision avoidance method, comprising:
receiving, from a light detection and ranging device (LIDAR) installed at a vehicle, a point cloud map representing a surrounding environment within a set range from the LIDAR;
receiving, from a camera installed at the vehicle, an image of the surrounding environment;
determining whether an object that is expected to collide with the vehicle is present in the point cloud map;
in response to a determination that the object is present in the point cloud map, activating an avoidance traveling process;
setting a collision avoidance space defined to avoid the object according to the avoidance traveling process;
identifying a type of the object based on a region of interest that is set according to a location of the object in the image;
based on identifying the type of the object, determining whether the type of the object corresponds to a set avoidance target; and
driving the vehicle to the collision avoidance space in response to a determination that the type of the object corresponds to the set avoidance target.

14. The vehicle collision avoidance method of claim 13, wherein receiving the point cloud map comprises receiving a plurality of point cloud maps from the LIDAR at set intervals, and
wherein the method further comprises:
transforming each point cloud map from a three-dimensional point cloud map to a two-dimensional occupancy grid map (OGM),
comparing OGMs corresponding to the plurality of point cloud maps, each OGM comprising an occupied area in which one or more objects are expected to be present,
based on comparing the OGMs, determining movement of the one or more objects in the occupied area,
based on determining the movement of the one or more objects in the occupied area, determining object information corresponding to the one or more objects in the occupied area, the object information comprising at least one of a speed of the one or more objects, a traveling direction of the one or more objects, a size of the one or more objects, or a distance between the one or more objects and the vehicle, and
based on the object information, determining whether the one or more objects correspond to the object that is expected to collide with the vehicle.

15. The vehicle collision avoidance method of claim 14, wherein determining whether the one or more objects correspond to the object that is expected to collide with the vehicle comprises:
determining that the one or more objects correspond to the object that is expected to collide with the vehicle based on (i) the size of the one or more objects being greater than a set size, (ii) the speed of the one or more objects toward the vehicle being greater than a set speed, and (iii) the distance between the one or more objects and the vehicle being less than a set separation distance.

16. The vehicle collision avoidance method of claim 14, further comprising:
receiving a high definition (HD) map from a server, the HD map comprising lane information,
wherein determining whether the one or more objects correspond to the object that is expected to collide with the vehicle comprises:
estimating movement of the one or more objects based on the object information,
determining whether the estimated movement of the one or more objects is normal according to the lane information in the HD map, and
based on a determination that the estimated movement of the one or more objects is abnormal, determining that the one or more objects correspond to the object that is expected to collide with the vehicle.

17. The vehicle collision avoidance method of claim 13, further comprising:
before setting the collision avoidance space, causing the vehicle to perform a collision prevention operation by decelerating, accelerating, or steering the vehicle based on a distance between the object and the vehicle being greater than a set braking distance of the vehicle.

18. The vehicle collision avoidance method of claim 13, wherein driving the vehicle to the collision avoidance space comprises:
determining that the vehicle is expected to collide with the object based on a distance between the object and the vehicle being less than a set braking distance of the vehicle; and
in response to a determination that the vehicle is expected to collide with the object, driving the vehicle to the collision avoidance space.

19. The vehicle collision avoidance method of claim 13, wherein driving the vehicle to the collision avoidance space comprises:
setting an avoidance area comprising non-travelable areas that the vehicle is not allowed to enter;
setting the avoidance area and a travelable area of the vehicle as the collision avoidance space; and
driving the vehicle to the collision avoidance space to avoid a collision between the vehicle and the object.

20. The vehicle collision avoidance method of claim 13, wherein identifying the type of the object in the region of interest in the image comprises:
in response to a determination that the object is present in the point cloud map, setting an area corresponding to spatial coordinates of the object in the image as the region of interest;
increasing a frame rate of the camera for capturing images of the region of interest; and
identifying the type of the object based on the images captured at the frame rate.
